(19) United States
(12) Patent Application Publication
(10) Pub. No.: US 2017/0340169 A1
(43) Pub. Date: Nov. 30, 2017

(54) MULTI-POSITION FOOD PROCESSOR SYSTEM

(71) Applicant: SharkNinja Operating LLC, Newton, MA (US)

(72) Inventor: Charles Stewart Brunner, North Reading, MA (US)

(21) Appl. No.: 15/605,293

(22) Filed: May 25, 2017

Related U.S. Application Data
(60) Provisional application No. 62/341,201, filed on May 25, 2016.

(51) Int. Cl. A47J 43/07; A47J 43/046

(52) U.S. Cl. CPC A47J 43/0722; A47J 43/046

(57) ABSTRACT

A system for processing food items includes a rotatable cutting component capable of performing a plurality of food processing operations and a container for receiving a food item processed by said rotatable cutting component. The plurality of food processing operations are selected by a position of said food item as said food item engages said cutting component.

### CROSS REFERENCE TO RELATED APPLICATIONS

This application claims the benefit of U.S. Provisional Application No. 62/341,201, filed May 25, 2016, the content of which is incorporated by reference in its entirety herein.

### BACKGROUND

This application is directed to a food processor, and more particularly, to a food processor having one or more unique features designed for enhancing the safety, ease of use, and/or versatility of the food processor.

Blenders are commonly used to process a plurality of different food products, including liquids, solids, semi-solids, gels and the like. It is well-known that blenders are useful devices for blending, cutting, and dicing food products in a wide variety of commercial settings, including home kitchen use, professional restaurant or food services use, and large-scale industrial use. They offer a convenient alternative to chopping or dicing by hand, and often come with a range of operational settings and modes adapted to provide specific types or amounts of food processing, e.g., as catered to particular food products.

### SUMMARY

According to one embodiment, a system for processing food items includes a rotatable cutting component capable of performing a plurality of food processing operations and a container for receiving a food item processed by said rotatable cutting component. The plurality of food processing operations are selected by a position of said food item as said food item engages said cutting component.

In addition to one or more of the features described above, or as an alternative, in further embodiments said rotatable cutting component includes a first portion and a second portion, wherein a first food processing operation is selected when said food item is aligned with said first portion, and wherein a second food processing operation is selected when said food item is aligned with said second portion.

In addition to one or more of the features described above, or as an alternative, in further embodiments said first portion of said rotatable cutting component is substantially aligned with an axis of rotation of said rotatable cutting component.

In addition to one or more of the features described above, or as an alternative, in further embodiments said second portion of said rotatable cutting component is offset from an axis of rotation of said rotatable cutting component.

In addition to one or more of the features described above, or as an alternative, in further embodiments one of said plurality of food processing operations includes forming one or more semi-continuous lengths of said food item.

In addition to one or more of the features described above, or as an alternative, in further embodiments one of said plurality of food processing operations includes slicing, grinding or shredding said food item.

In addition to one or more of the features described above, or as an alternative, in further embodiments comprising a lid including an opening arranged in communication with said rotatable cutting component, said opening being movable to provide a food item to said rotatable cutting component at a plurality of positions.

In addition to one or more of the features described above, or as an alternative, in further embodiments said opening is configured to slide between said plurality of positions.

In addition to one or more of the features described above, or as an alternative, in further embodiments said opening is configured to rotate between said plurality of positions.

In addition to one or more of the features described above, or as an alternative, in further embodiments said rotatable cutting component includes a blade disc driven about an axis of rotation.

In addition to one or more of the features described above, or as an alternative, in further embodiments said blade disc is driven about said axis of rotation by a motor.

In addition to one or more of the features described above, or as an alternative, in further embodiments said blade disc is driven about said axis of rotation manually.

In addition to one or more of the features described above, or as an alternative, in further embodiments said first portion includes a receiver having at least one cutting edge.

In addition to one or more of the features described above, or as an alternative, in further embodiments said second portion includes a slicing slot and a slicing blade is arranged adjacent said slicing slot.

In addition to one or more of the features described above, or as an alternative, in further embodiments said slicing slot extends across a radius of said blade disc such that said slicing blade enables creation of a semi-continuous cut when said food item is aligned with said first portion.

A method of operating a food processing system includes installing a rotatable cutting component into a chamber of a food processor. The rotatable cutting component is capable of performing a plurality of food processing operations. A food item is positioned adjacent the food processor. The position of the food item as the food item engages the rotatable cutting component selects one of the plurality of food processing operations to be performed.

### BRIEF DESCRIPTION OF THE FIGURES

The accompanying drawings incorporated in and forming a part of the specification embodies several aspects of the present invention and, together with the description, serves to explain the principles of the invention. In the drawings:

FIG. 1 is a perspective view of an example of a food processing system;

FIG. 2 is a perspective view of a food processing system having a chute arranged at a center of the lid according to an embodiment;

FIG. 3 is a perspective view of a food processing system having a chute arranged at an edge of the lid according to an embodiment;

FIG. 4 is a perspective view of an attachment associated with the food processing system according to an embodiment; and

FIG. 5 is a perspective view of the attachment positioned within a container of the food processing system according to an embodiment.

The detailed description explains embodiments of the invention, together with advantages and features, by way of example with reference to the drawings.

### DETAILED DESCRIPTION

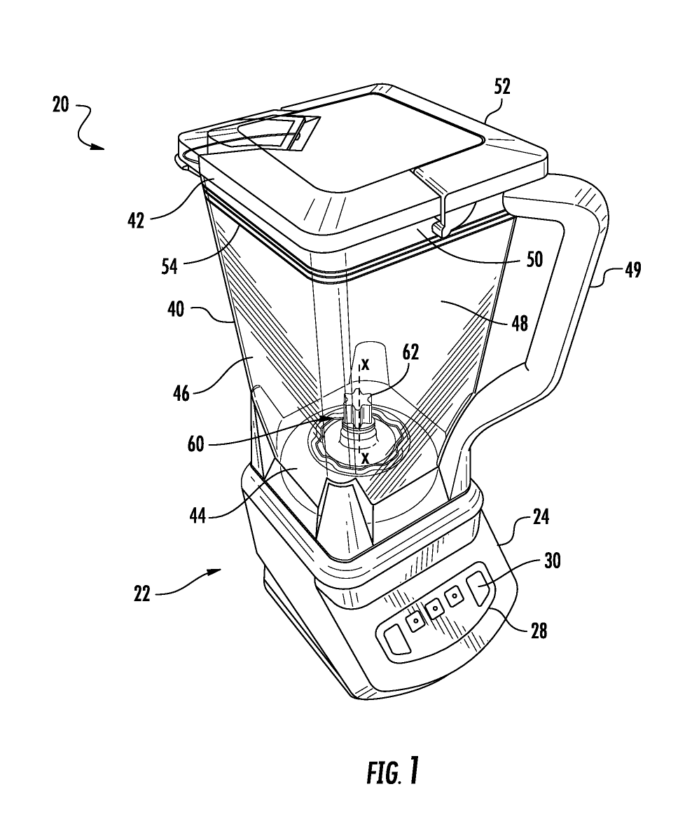

Referring now to the FIG. 1, an example of a multi-functional food processing system 20 is illustrated in more detail. In general, the food processing system 20 can be adapted to perform any food processing or blending operation including as non-limiting examples, dicing, chopping, cutting, slicing, mixing, blending, stirring, crushing, or the like. Although an example of a food processing system 20 is illustrated and described herein, other food processing systems are within the scope of the present disclosure. The food processing 20 system includes a base 22 having a body or housing 24 within which a motorized unit (not shown) and at least one controller (not shown) are located. The base 22 includes at least one rotary component, such as a drive coupler (not shown) for example, driven by the motorized unit within the body 24. The base 22 additionally includes a control panel or user interface 28 with including at least one input device 30 for turning the motorized unit on and off and for selecting various modes of operation, such as pulsing, blending, or continuous food processing.

The food processing system 20 additionally includes a container 40 adapted (e.g. sized and dimensioned) to receive one or more food products therein to be processed. The container 40 generally includes a first end 42, a second end 44, and one or more walls 46 extending there between to define an interior chamber 48 within which food products are placed and processed. As shown in the illustrated, non-limiting embodiment, a handle 49 may be integrally formed with at least a portion of the container 40, such as a sidewall 46 for example. As best shown in the embodiment illustrated in FIG. 1, the top 42 of the container 40 includes an opening 50 that provides access for the one or more food items into the chamber 48. The second end 44 is generally closed such that food products contained within the chamber 48 are unable to escape through the second end 44.

A lid 52 generally complementary in size to the opening 50 is attached to the first end 42 of the container 40. The lid 52 may be removably secured to the container 40, such as via a plurality of threads, a press-fit configuration, or any other suitable type of connection for example. Alternatively, the lid 52 may be configured to fixedly attach to the first end 42 of the container 40. Inclusion of the lid 52, such as during a food processing and/or blending operation restricts movement of the one or more food products from the chamber 48 via the first end 42 of the container 40. In one embodiment, the lid 52 may be shaped or include one or more features to prevent the accumulation of food particles thereon. In addition, a gasket 54 may be positioned between the lid 52 and the first end 42 to form a seal preventing a food product from spilling out at the interface between the lid 52 and the opening 50.

Depending on the type of food processing system 20 being used, the container 40 may be configured to slidably or rotatably attach to the base 22. In the illustrated, non-limiting embodiment, the container 40 is moved vertically to connect to the base 22. However, in other embodiments, sliding and/l or rotational movement of the container 40 in a direction other than the direction of downward movement of the container 40 onto the base 22 may be necessary to successfully mount the container 40 to the base 22. In one embodiment, the connection formed between the base 22 and the container 40 is intended to limit unintended movement of the container 40 relative to the base 22 during operation of the food processing system 20.

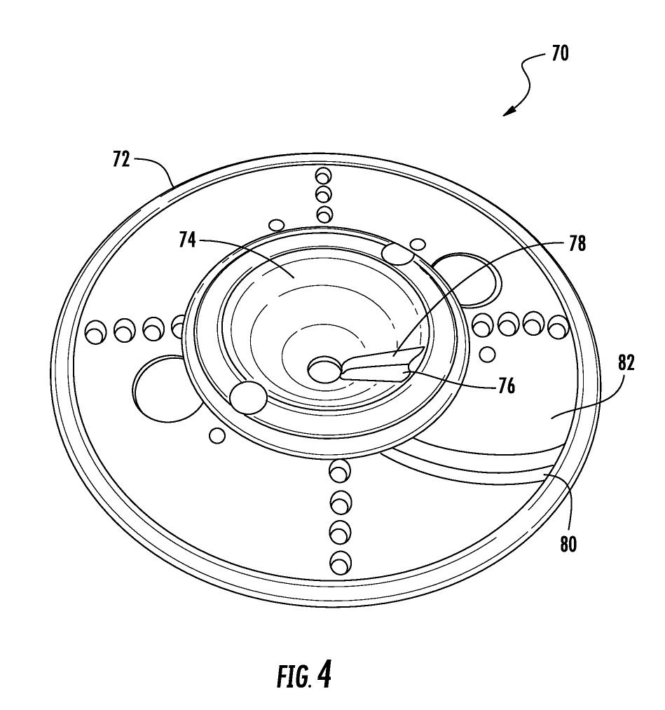

In the illustrated, non-limiting embodiment, a rotatable assembly 60 including a spindle 62 extends through the second end 44 into the chamber 48 of the container 40. Mounted to a portion of the spindle 62 adjacent an underside of the container 40 is a coupling component (not shown) configured to engage the rotary component of the base 22. As a result of this engagement, the motorized unit within the base 22 may be used to drive rotation of the spindle 62 about an axis X-X. A plurality of interchangeable attachments 70, such as shown in FIG. 4 for example, varying in size and/or functionality may be configured for use with the rotatable assembly 60 for the processing of food products located within the chamber 48 of container 40.

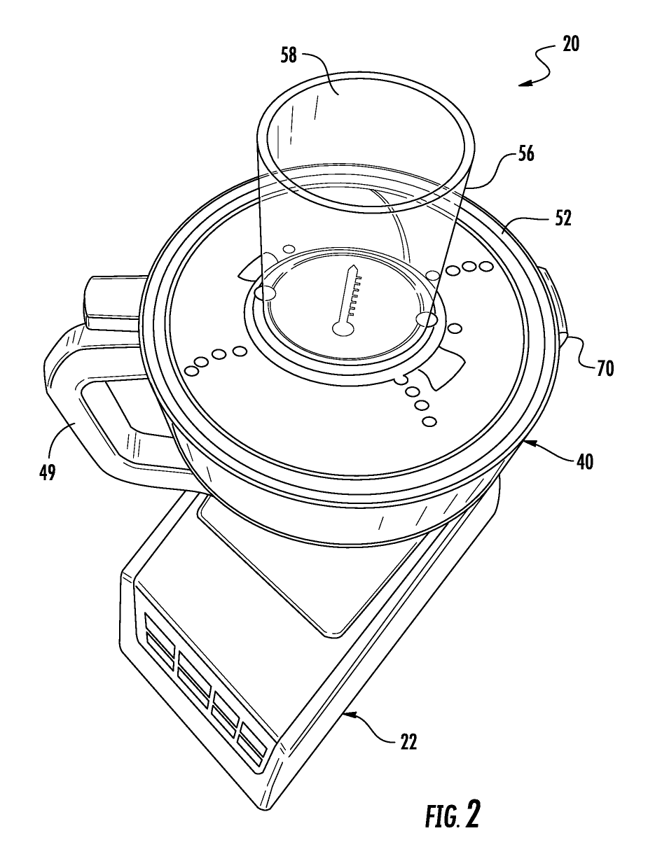

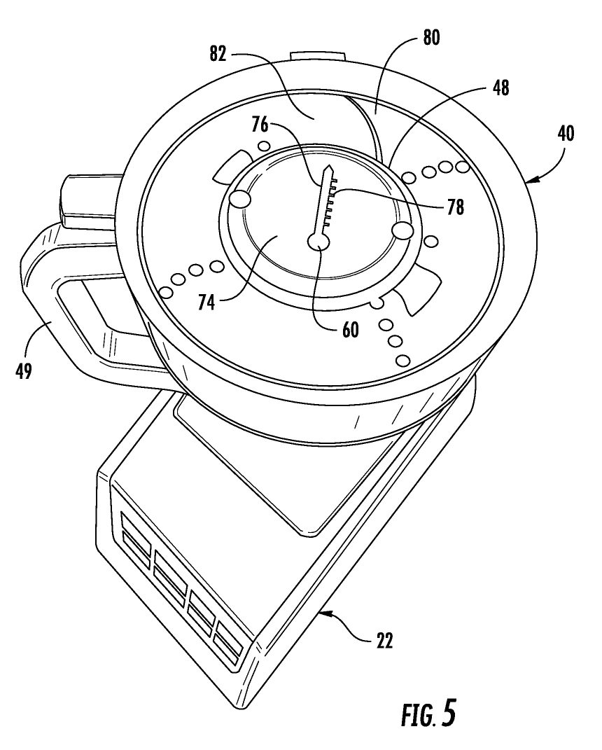

Referring now to FIGS. 2-5, a food processing system 20, such as shown in FIG. 1 for example, including an attachment configured to perform a plurality of distinct food processing operations based on a position of a food item relative to the container 40 is illustrated. A blade disc 70, best illustrated in FIG. 4, is mountable to a portion of the rotatable assembly 60, such as the spindle 62 for example, within the chamber 48 of the container 40 for driven rotation about axis X. A central portion of the blade disc 70 includes at least one cutting tool configured to perform a first cutting operation on a food item aligned therewith. As shown, the central portion of the blade disc 70 is configured to function as a spiralizer and form one or more semi-continuous lengths of a food item, similar to noodles for example.

In the illustrated, non-limiting embodiment, a receiver is arranged at a center of an upper surface 72 of the blade disc 70. As shown, the receiver 74 is generally conical in shape such that a first end of the receiver (not shown), such as the apex end thereof, is attached to or is integrally formed with the blade disc 70. It should be understood that the receiver 74 illustrated and described herein is intended as an example only and other shapes are also within the scope of the disclosure. The receiver 74 is configured to receive any of a variety of foods, including fruits and vegetables, such as, zucchini, cucumber, potato, carrot, and squash for example. Formed in the receiver 74 is a slot 76 and at least one cutting edge 78 arranged directly adjacent the slot 76. The slot 76 and cutting edge 78 may extend vertically and/or circumferentially in a sidewall of the receiver 74. In addition, the orientation and type of cutting edge 78 may be varied to achieve different shapes and textures. In embodiments including more than one cutting edge, each strand or semi-continuous length of the food item formed by a respective cutting edge 78 may be substantially identical, or alternatively, may be different. The receiver 74 illustrated and described relative to the central portion of the blade disc 70 is intended as an example only, and it should be understood that other types of cutting tools configured to perform any suitable food processing operation may be connected to or integrally formed with the central portion of the blade disc 70.

A second, non-central portion of the blade disc 70 is configured to perform a second food processing operation, distinct from the food processing operation at the central portion of the blade disc 70. In the illustrated, non-limiting embodiment, the second portion of the blade disc 70 additionally includes a slot 80 and at least one first blade 82 mounted directly adjacent the slot 80, generally within the plane of the blade disc 70. The at least one blade 82 may, but need not, extend over the full radius of the blade disc 70 and in the illustrated, non-limiting embodiment is configured to contact and slice a food item. In embodiments where the blade 82 extends over the full radius of the blade disc 70, the slicing blade may contribute to the creation of the semi-continuous cuts formed when a food is aligned with the central portion of the blade disc 70. However, it should be understood that the non-central portion of the blade disc 70 may consist of any of a plurality of different cutting tools. For example, the non-central portion of the blade disc 70 may not include a slot 80 or blade 82 as described, and instead include a tool configured to shred, grind, or grate a food item instead of slicing it.

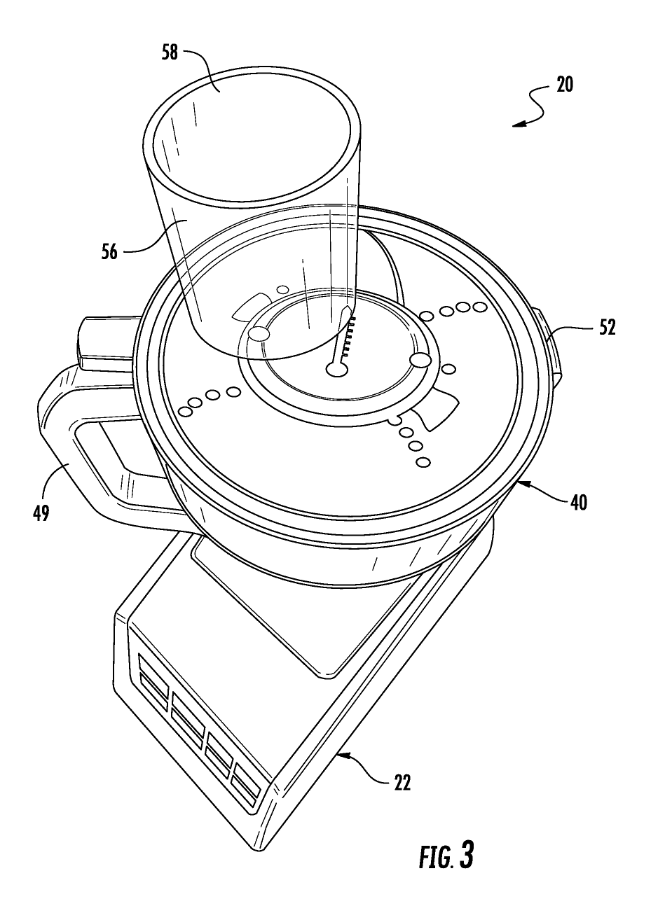

To operate the food processing system 20, an operator couples the blade disc 70 to the rotatable assembly 60 within the chamber 48 of the container 40. The user will then couple the lid 52 to the first end 42 of the container 40. The lid 52 of the food processing system 20 includes a chute 56 having a passageway 58 through which a food item may be inserted into the chamber 48 of the container 40 for processing. In conventional food processing systems, the chute 56 is formed as an integral portion of the lid 52 and is therefore arranged at a fixed location relative to the lid 52. In the embodiment of the food processing system 20 illustrated in FIGS. 2-5, the chute 56 is movable between a plurality of positions relative to the lid 52. As shown, the chute 56 is configured to slide or rotate for example, between a first position arranged generally at a center of the lid (FIG. 2), and a second position adjacent an outer periphery of the lid (FIG. 3). By positioning the chute 56 at the center of the lid 52, the passageway 58 of the chute 56 is substantially aligned with the receiver 74 of the blade disc 70. A food item inserted through the chute 56 into the centrally located receiver 74 is sliced into noodles as the blade disc 70 rotates about the food item.

When the chute 56 is positioned adjacent an edge of the lid 52, the chute 56 is substantially aligned with the outer portion of the blade disc 70. In this position, a food item extending through the passageway 58 of the chute 56 is cut into slices by the blade 82 as the blade disc 70 rotates about the axis X. In an embodiment, the at least one blade 82 configured to perform the second food processing operate may have two or more sections arranged over the radial length thereof. In an embodiment, each section is associated with a corresponding position of the feed chute 56 and is configured to provide a cut piece of a food item having one or more distinct properties. For example, the different sections of the blade 82 may be configured to create food items cut into distinct thicknesses.

The user may therefore select the position of the chute based on which food processing operation he or she desires. Although the blade disc is illustrated and described as being driven about an axis of rotation automatically by a motor, it should be understood that other embodiments where rotation of the blade disc is driven manually, such as by operation of a crank for example, are also within the scope of the disclosure.

The food processing systems 20 described herein provide the user with increased functionality for an attachment associated with the system 20. A user will no longer need to continually replace components of the system 20 to achieve different size cuts or slices.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for processing food items, comprising:
a rotatable cutting component capable of performing a plurality of food processing operations; and
a container for receiving a food item processed by said rotatable cutting component, wherein said plurality of food processing operations are selected by a position of said food item as said food item engages said cutting component.

2. The system according to claim 1, wherein said rotatable cutting component includes a first portion and a second portion, wherein a first food processing operation is selected when said food item is aligned with said first portion, and wherein a second food processing operation is selected when said food item is aligned with said second portion.

3. The system according to claim 2, wherein said first portion of said rotatable cutting component is substantially aligned with an axis of rotation of said rotatable cutting component.

4. The system according to claim 2, wherein said second portion of said rotatable cutting component is offset from an axis of rotation of said rotatable cutting component.

5. The system according to claim 1, wherein one of said plurality of food processing operations includes forming one or more semi-continuous lengths of said food item.

6. The system according to claim 1, wherein one of said plurality of food processing operations includes slicing, grinding or shredding said food item.

7. The system according to claim 1, further comprising a lid including an opening arranged in communication with said rotatable cutting component, said opening being movable to provide a food item to said rotatable cutting component at a plurality of positions

8. The system according to claim 7, wherein said opening is configured to slide between said plurality of positions.

9. The system according to claim 7, wherein said opening is configured to rotate between said plurality of positions.

10. The food processing system according to claim 2, wherein said rotatable cutting component includes a blade disc driven about an axis of rotation.

11. The food processing system according to claim 10, wherein said blade disc is driven about said axis of rotation by a motor.

12. The food processing system according to claim 10, wherein said blade disc is driven about said axis of rotation manually.

13. The food processing system according to claim 10, wherein said first portion includes a receiver having at least one cutting edge.

14. The food processing system according to claim 10, wherein said second portion includes a slicing slot and a slicing blade is arranged adjacent said slicing slot.

15. The food processing system according to claim 14, wherein said slicing slot extends across a radius of said blade disc such that said slicing blade enables creation of a semi-continuous cut when said food item is aligned with said first portion.

16. A method of operating a food processing system, comprising:
installing a rotatable cutting component into a chamber of a food processor, said rotatable cutting component being capable of performing a plurality of food processing operations; and
positioning a food item adjacent said food processor, wherein a position of said food item as said food item engages said rotatable cutting component selects one of said plurality of food processing operations to be performed.

17. The method according to claim 16, wherein said food item may be provided to said food processor at one of a first, central position associated with said first region and a second position adjacent a periphery of said food processor associated with said second region.
